(19) United States
(12) Patent Application Publication
(10) Pub. No.: US 2014/0339787 A1
(43) Pub. Date: Nov. 20, 2014

(54) Multiple Speed Planetary Gear Hub for a Stepping Motion Propelled Bicycle, tricycle or Vehicle

(71) Applicant: Miguel Angel Chung, Inman, SC (US)

(72) Inventor: Miguel Angel Chung, Inman, SC (US)

(21) Appl. No.: 13/895,410

(22) Filed: May 16, 2013

(51) Int. Cl. B62M 1/30

(52) U.S. Cl. CPC B62M 1/30
USPC 280/257

(57) ABSTRACT

The invention relates to a multiple speed planetary gear hub for a stepping motion lever propelled bicycle, tricycle or vehicle. The planetary gear hub consist of two or more planetary gear sets mounted in series rotatable around a drive shaft, and a speed selector or control device to select the desired gear ratios.

### BACKGROUND OF THE INVENTION

The most common multiple speed bicycle uses a chain and derailleur system driven by a pedal and rotating crank. The circular motion of the pedals implies a sinusoidal torque for each crank revolution, producing maximum torque when crank arm is in the horizontal position and zero torque when crank arm is in the vertical position. The efficiency of this system is 78% in relation to a pedal lever up and down motion, where the input torque is nearly constant.

Chain and derailleur system is also troublesome for maintenance, increasing if bicycle is ridden extensively on dirt road and trails, or in contact with rocks or branches, the derailleur components can be damaged. A planetary gear hub eliminates these disadvantages.

### SUMMARY OF THE INVENTION

The objective of this invention is to increase torque input by using a pedal lever with up and down motion, instead of a rotating crank; and to reduce maintenance in relation to the chain and derailleur system by using a multiple speed chainless sealed planetary gear hub located at the bicycle, tricycle or vehicle wheel axis.

The chainless sealed planetary gear hub includes: a pedal lever attached to a backstop freewheel mounted on the ends of the drive shaft coaxial to the wheel shaft; a pulley system with flexible cable attached to the pedal levers; two or more planetary gear sets, mounted in series, all rotatable around the drive shaft; a fitting on the drive shaft to drive the first planet gear carrier; a mechanical means for selectively locking the ring gear of each planetary gear set; and an over-run freewheel, for coupling the last planetary gear set to the wheel hub.

The number of speed stages is defined by the number of planetary gear sets in the planetary gear hub. For example, using three planetary gear sets, provides three speeds by locking the ring gear respectively of each planetary gear set. In addition, a direct drive is obtained by letting all the planetary gear sets' ring gear rotate freely. In this manner a total of four speeds are available with this particular planetary gear hub.

### REFERENCE DRAWINGS

FIG. 1—Bicycle with Planetary Gear Hub and Pedal Lever.

FIG. 2—Multiple Speed Planetary Gear Hub Diagram.

FIG. 3—Multiple Speed Planetary Gear Hub Sectional View.

FIG. 4—FIG. 3 Section View “A-A”.

FIG. 5—Speed Selector Locking Ring Detail.

### DETAIL DESCRIPTION OF THE INVENTION

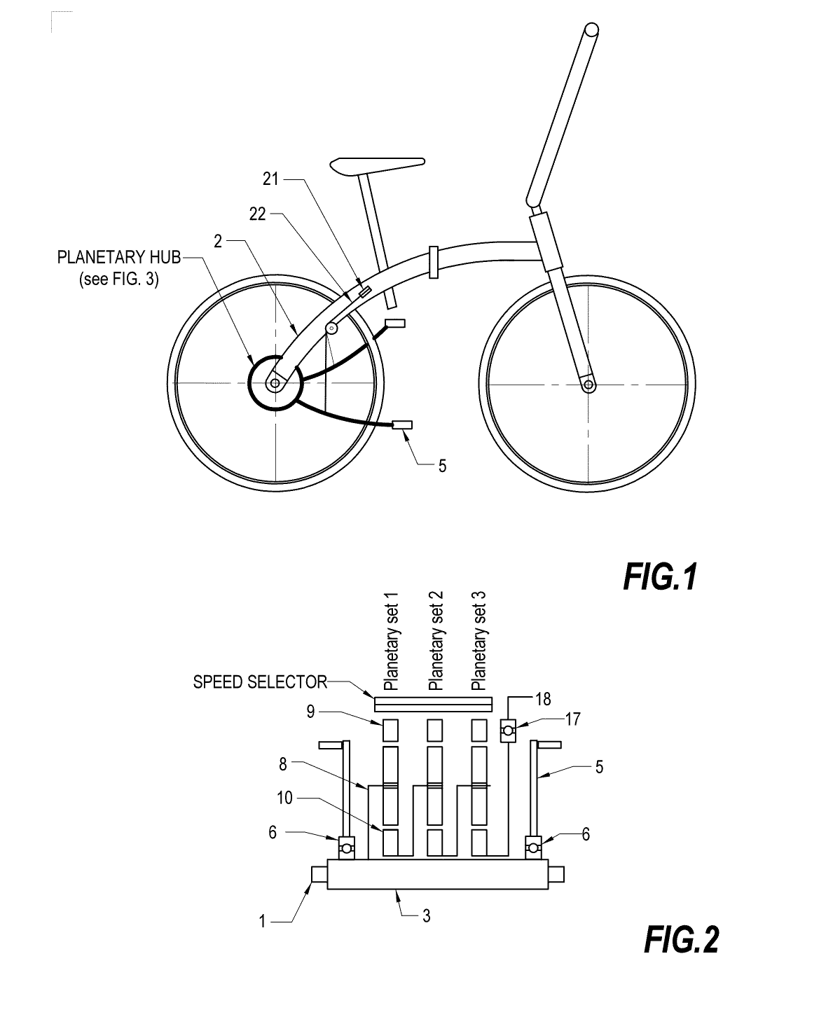

FIG. 1 illustrates a bicycle with the multiple speed planetary gear hub in the rear wheel axis; a pedal lever 5 on both sides of the planetary gear hub where stepping force is applied; and a pulley system 21 with flexible cable 22 which assist the pedal lever in up-down motion. In FIG. 2, the planetary gear hub diagram shows the functionality and main components: wheel shaft 1, drive shaft 3, pair of pedal lever 5, pair of backstop freewheel 6, planet gear carrier 8, ring gear 9, sun gear 10, over-run freewheel 17, and wheel hub 18.

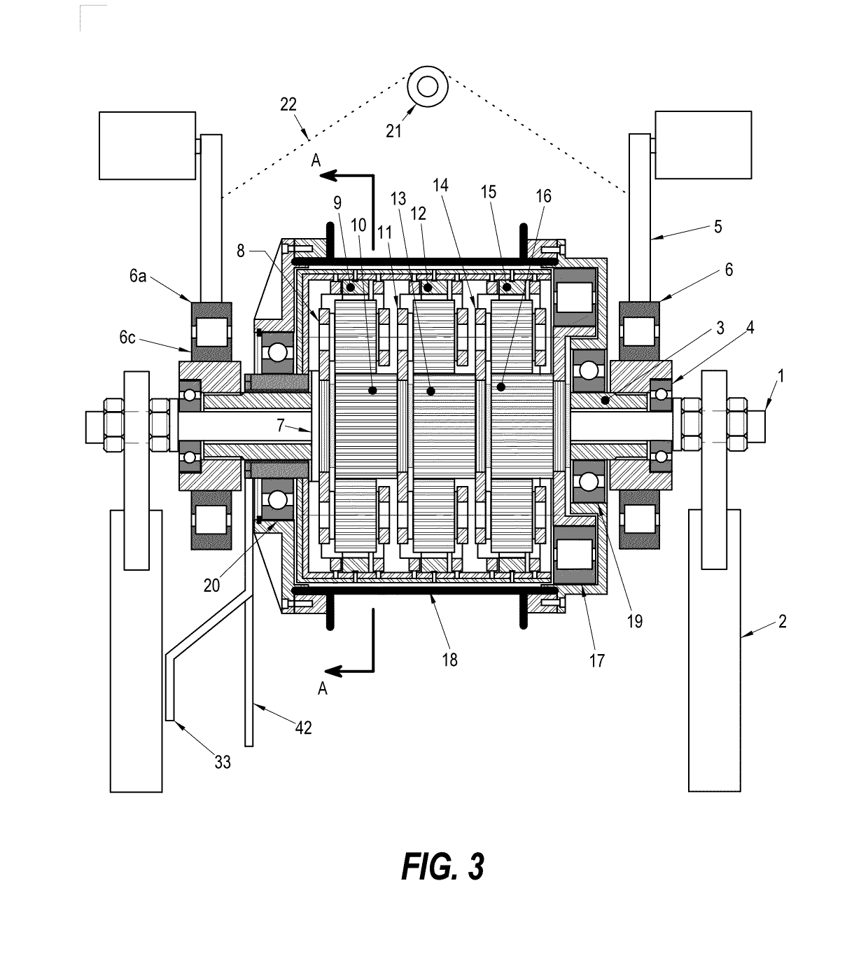

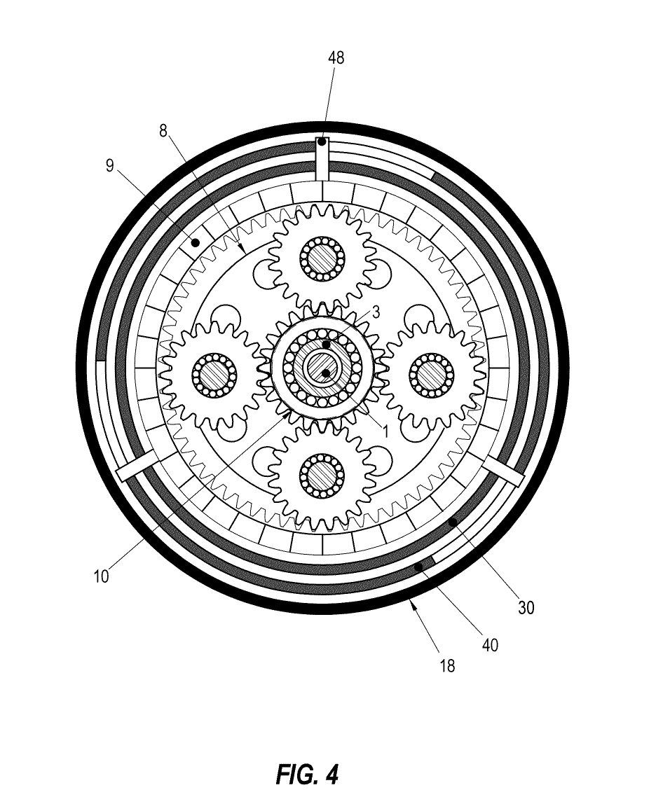

In accordance to FIG. 3, the multiple speed planetary gear hub contains a wheel shaft 1, whose ends are bolted to the bicycle frame 2, fixed against rotation. On the drive side the hollow drive shaft 3 is coaxial and rotatable to the wheel shaft 1 and supported by ball bearings 4. Pedal lever 5 provides up and down movement assisted by a pulley system 21 and flexible cable 22; the pedal lever 5 is fixed to the backstop freewheel's outer ring 6a, and the inner ring 6c is connected to the drive shaft 3 spline ends; the pair of backstop freewheel 6 converts the up and down movement of the pedal lever to a one directional rotation of the drive shaft 3. A drive fitting 7 fixed to the drive shaft 3, transfers torque to the planet gear carrier 8 of the first planetary gear set meshed within the ring gear 9 and rotating the sun gear 10 that connects to the second planetary gear set's planet gear carrier 11, meshed within the ring gear 12 and rotating the sun gear 13 that connects to the third planetary gear set's planet gear carrier 14, meshed within the ring gear 15 and rotating the last sun gear 16 that rotates the wheel hub 18 through a over run freewheel 17; it is understood that the described sun gears 10, 13, 16 in all three stages can rotate around the drive shaft 3 as shown in FIG. 4. The wheel hub 18 is seated to the drive shaft 3 by means of ball bearings 19 and 20.

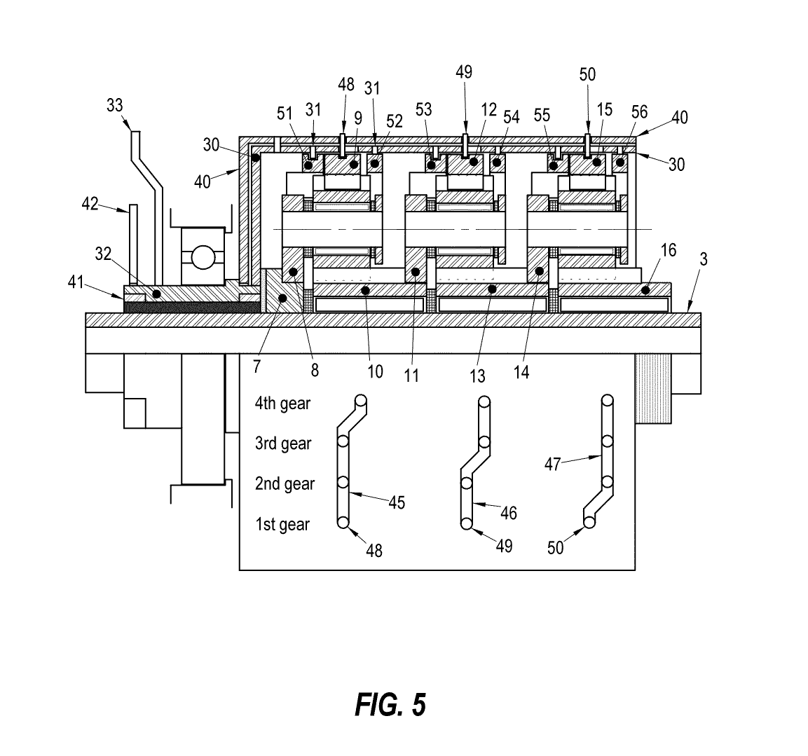

In accordance to FIG. 5, the speed selector or gearshift mechanism is shown for four speeds. The inner cylinder 30 with pins 31 guide and space the planetary lock rings 51, 52, 53, 54, 55, 56; the inner cylinder outboard end 32 and lever 33 anchors the inner cylinder 30 to the bicycle frame 2. The outer cylinder 40 rotates around the inner cylinder 30 by rotating shift lever 42 that is connected to the outer cylinder outboard end 41; and has three slots 45, 46, 47 with respective pins 48,49,50 which move axially the gear rings 9, 12, 15 intended to engage the lock rings 51, 52, 53, 54, 55, 56 for speed selection. Placing the shift lever 42 in first gear, gear ring 9, 12, 15 engages lock ring 51, 53, 55 with planet gear carrier 8, 11, 14 rotating together about the drive shaft; placing the shift lever 42 in second gear, gear ring 9,12 engages lock ring 51, 53 with planet gear carrier 8,11 rotating together about the drive shaft, and gear ring 15 engages lock ring 56 fix to inner cylinder 30; placing the shift lever 42 in third gear, gear ring 9 engages lock ring 51 with planet gear carrier 8 rotating together about the drive shaft, and gear ring 12, 15 engages lock ring 54, 56 fix to inner cylinder 30; placing the shift lever 42 in fourth gear, gear ring 9, 12, 15 engages lock ring 52, 54, 56 fix to inner cylinder 30.

From the above description when the planet gear carrier 8 is driven by drive shaft 3 and the ring gear 9, 12, 15 is locked against rotation with lock ring 52, 54, 56 the ratio of the wheel hub rpm to the pedal-lever rpm is given by (N/n+1)^{s}, where N=number of teeth on the ring gear, n=number of teeth on the sun gear, and s=number of ring gear locked against rotation. Using a 64 teeth ring gear, 24 teeth sun gear and three planetary gear sets in series, the ratio of the wheel hub rpm to the pedal-lever rpm is: when shift lever 42 is in first gear the ratio is 1; when shift lever 42 is in second gear the ratio is 3.666; when shift lever 42 is in third gear the ratio is 13.44; and when shift lever 42 is in fourth gear the ratio is 49.27.

The invention is not limited to the above description, which can be changed. It is in particular possible to assign more than three planetary gear sets, in order to provide additional speed ratios. Furthermore, gear teeth numbers different from the ones mentioned can be specified.

I claim:

1. A multiple speed planetary gear hub for a stepping motion lever propelled bicycle, tricycle or vehicle comprising of:
A non-rotatable wheel shaft bolted to the bicycle frame;
A hollow drive shaft rotatable around of said wheel shaft;
A backstop freewheel at both spline ends of said drive shaft;
A pedal lever fixed to the outer ring of each said backstop freewheel;
A pulley system with flexible cable, attached to the bicycle frame and to said pedal lever, for up and down motion.
Two or more planetary gear sets mounted in series for concentric rotation about said drive shaft;
A drive fitting fixed to said drive shaft for engaging the first stage planet gear carrier in said planetary gear sets;
A speed selector for engaging the planetary ring gears for different speed ratios;
A over-run freewheel to connect the last planetary gear set to the wheel hub;

2. A multiple speed planetary gear hub accordance to claim 1 wherein said pulley system and pedal lever fixed to the backstop freewheel, converts the pedals up and down motion to a one directional rotation of the drive shaft.

3. A multiple speed planetary gear hub accordance to claim 1 wherein said drive fitting fixed to the drive shaft transfer the drive shaft rotation to the multiple planetary gear sets mounted in series.

4. -A multiple speed planetary gear hub accordance to claim 1 wherein said speed selector consist of two cylindrical shell, inner and outer, concentric to the planetary gear sets; and
two lock rings sandwiching the ring gear of each planetary gear set. The inner cylindrical shell, is fixed to the bicycle frame by a lever, with row of pins to guide and space the lock rings keeping them in relative position to each other. The outer cylindrical shell rotates around the inner cylindrical shell, and has a selective shift lever and parallel s-slots to control the ring gears axial position, locking the ring gear to the planet gear carrier or locking the ring gear to the inner cylindrical shell.
